(19) United States
(12) Patent Application Publication
(10) Pub. No.: US 2016/0094130 A1
(43) Pub. Date: Mar. 31, 2016

(54) REDUCING SWITCHING LOSSES IN FLYBACK CONVERTERS

(71) Applicant: Apple Inc., Cupertino, CA (US)

(72) Inventor: Zaohong Yang, Plano, TX (US)

(21) Appl. No.: 14/498,578

(22) Filed: Sep. 26, 2014

(51) Int. Cl. H02M 3/335

(52) U.S. Cl. CPC H02M 3/33507

(57) ABSTRACT

The disclosed embodiments present a flyback voltage converter that reduces switching losses in a primary-side switching transistor. This flyback converter includes a primary current path that feeds from an input power source into a voltage input of the flyback converter, then through a primary winding of a transformer and a primary transistor to a primary ground. It also includes a secondary current path that feeds from a secondary ground through a secondary winding of the transformer and a diode to a voltage output. During operation, the flyback converter toggles the primary transistor on and off to cause current to flow in an alternating fashion through the primary and secondary current paths. During this toggling process, before the primary transistor is turned on, a parasitic capacitance from the primary transistor is discharged into a reservoir capacitor. This charge is subsequently used to facilitate power efficiency in the flyback converter.

### RELATED ART

The present embodiments relate to designs for flyback voltage converters. More specifically, the present embodiments relate to a technique for reducing switching losses in flyback converters.

### BACKGROUND

Because of its simplicity, ease of design and low cost, the flyback voltage converter is presently the most popular type of power-supply for converting alternating current (AC) to direct current (DC) in low-power and medium-power applications. Flyback converters are presently used to power a wide range of electronic devices, including cell phones, tablet computers, laptop computers, DVD players and set-top boxes.

Unfortunately, a conventional flyback converter operating in discontinuous-conduction-mode (DCM) suffers from a significant power-loss problem caused by discharging the parasitic drain-to-source capacitance of a primary-side MOSFET (switching transistor) whose initial voltage can be as high as the input voltage. A flyback converter operating in quasi-resonant-mode (QRM) alleviates this power-loss problem by reducing the switching voltage of the primary-side MOSFET by an LC resonant voltage. However, as energy-efficiency standards become progressively stricter, even a flyback converter operating in QRM is not sufficient to meet associated energy-efficiency requirements.

Hence, what is needed is a flyback converter that does not suffer from the power-loss problems that arise in conventional flyback converters operating in DCM and QRM.

### SUMMARY

The disclosed embodiments relate to a flyback voltage converter that reduces switching losses in a primary-side switching transistor. This flyback converter includes a primary current path that feeds from an input power source into a voltage input of the flyback converter, then through a primary winding of a transformer and a primary transistor to a primary ground. It also includes a secondary current path that feeds from a secondary ground through a secondary winding of the transformer and a diode to a voltage output that includes an output capacitor. During operation, the flyback converter toggles the primary transistor on and off to cause current to flow in an alternating fashion through the primary and secondary current paths. During this toggling process, before the primary transistor is turned on, a parasitic capacitance from the primary transistor is discharged into a reservoir capacitor. The charge stored in this reservoir capacitor is subsequently used to facilitate power efficiency in the flyback converter.

In some embodiments, discharging the parasitic capacitance includes discharging the primary transistor through a discharge current path that starts at a drain of the primary transistor and feeds through a diode, a resistor and a switch and then into the reservoir capacitor.

In some embodiments, discharging the parasitic capacitance includes discharging the primary transistor through a discharge current path that starts at a drain of the primary transistor and feeds through a diode, an inductor and a switch and then into the reservoir capacitor. In these embodiments, the inductor and the parasitic capacitance of the primary transistor comprise a resonant circuit that causes the drain-to-source voltage of the primary transistor to reach zero volts during the discharging process. In these embodiments, the primary transistor is turned on when the drain-to-source voltage of the primary transistor is close to zero volts.

In some embodiments, the charge stored in the reservoir capacitor is used to power a controller for the flyback converter.

In some embodiments, the charge stored in the reservoir capacitor is used to power a monitoring circuit that monitors one of a current and a voltage in the flyback converter.

In some embodiments, the charge from the reservoir capacitor is returned to the primary current path.

In some embodiments, the flyback converter operates in a quasi-resonant mode, wherein the parasitic capacitance starts discharging when the drain-to-source voltage of the primary transistor V_{DS} approaches a resonance valley, wherein the discharging of the parasitic capacitance causes V_{DS} to fall even further. Next, if the impedance element is a resistor, the primary transistor turns on when V_{DS} falls to V_{CC}. On the other hand, if the impedance element is an inductor, the primary transistor turns on when V_{DS} falls to approximately zero volts.

In some embodiments, the flyback converter operates in a discontinuous-conduction mode (DCM).

### BRIEF DESCRIPTION OF THE FIGURES

FIG. 1 illustrates a flyback converter in accordance with the disclosed embodiments.

FIG. 2A presents a diagram illustrating currents and voltages during operation of a continuous-conduction mode (CCM) flyback converter in accordance with the disclosed embodiments.

FIG. 2B presents a diagram illustrating currents and voltages during operation of a flyback converter operating in DCM in accordance with the disclosed embodiments.

FIG. 2C presents a diagram illustrating currents and voltages during operation of a flyback converter operating in QRM in accordance with the disclosed embodiments.

FIG. 3A presents a diagram illustrating currents and voltages during operation of a new V_{CC}-switching variation of a flyback converter operating in QRM that discharges a parasitic capacitance from the primary transistor through a resistor into a reservoir capacitor in accordance with the disclosed embodiments.

FIG. 3B presents a diagram illustrating the drain-to-source voltage for a primary-side transistor in a flyback converter operating in QRM in accordance with the disclosed embodiments.

FIG. 3C presents a diagram illustrating the drain-to-source voltage for a primary transistor in the new V_{CC}-switching variation of a flyback converter in accordance with the disclosed embodiments.

FIG. 4A illustrates how the parasitic capacitance of the primary transistor and an inductor in the discharge current path can form an LC resonant circuit in accordance with the disclosed embodiments.

FIG. 4B presents a timing diagram illustrating currents and voltages during operation of a zero-voltage-switching (ZVS) version of a flyback converter operating in QRM in accordance with the disclosed embodiments.

FIG. 4C presents another timing diagram illustrating currents and voltages during operation of a ZVS version of a flyback converter operating in QRM in accordance with the disclosed embodiments.

FIG. 4D presents yet another timing diagram illustrating currents and voltages during operation of a ZVS version of a flyback converter operating in QRM in accordance with the disclosed embodiments.

FIG. 5 presents a flow chart for the process of operating a flyback converter in accordance with the disclosed embodiments.

### DETAILED DESCRIPTION

### Flyback Converter

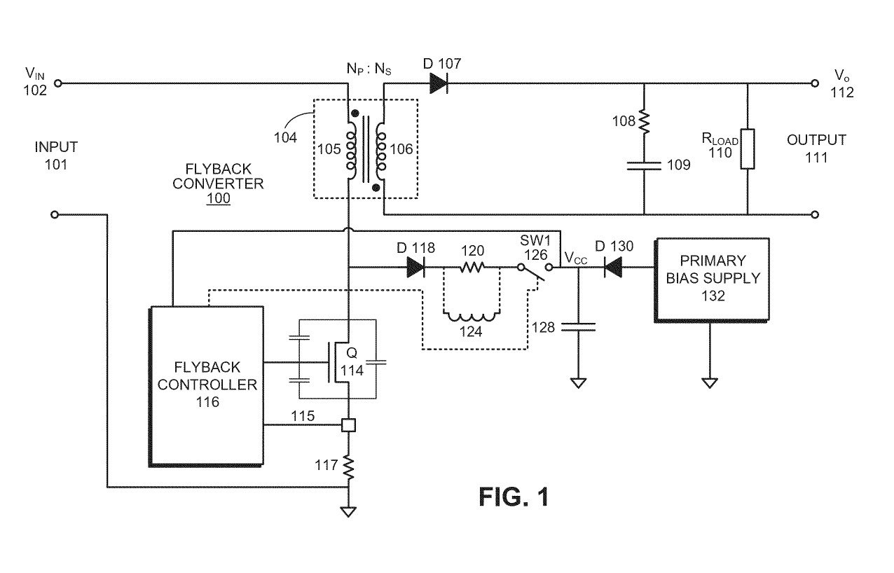

FIG. 1 illustrates a flyback converter 100 in accordance with the disclosed embodiments. Flyback converter 100 includes an input 101 that receives an input voltage V_{IN} 102 from a power source, such as AC power from a wall outlet by rectification, or from a DC power source such as a battery. Flyback converter 100 converts this input voltage into an output voltage V_{O} 112, such as a DC output voltage, that is provided though an output 111 to drive a load R_{LOAD} 110, which for example can be an electronic device. Note that output 111 is also coupled to an output capacitor 109 with an associated parasitic resistance 108.

Flyback converter 100 uses a transformer 104 to convert the input voltage V_{IN} 102 to the output voltage V_{O} 112, wherein transformer 104 includes a primary winding 105 and a secondary winding 106. Two current paths pass through transformer 104, including (1) a primary current path that starts at input 101 and then feeds through primary winding 105, a primary transistor Q 114 (e.g., a MOSFET, or a BJT Transistor) and a resistance 117 to a primary ground, and (2) a secondary current path that starts at a secondary ground and feeds through the secondary winding 106 and a diode D 107 to output 111. (Note that diode D 107 can possibly be replaced with a switching transistor. Also note that primary transistor Q 114 includes parasitic capacitances as illustrated by the small capacitors surrounding primary transistor Q 114.)

Flyback converter 100 operates generally as follows. When primary transistor Q 114 is turned on, current flows through the primary current path from input 101 into primary winding 105 and causes energy to be stored in the magnetizing inductor of transformer 104. When primary transistor Q 114 is subsequently turned off, the energy stored in the magnetizing inductor of transformer 104 is transferred through the secondary current path to output load R_{LOAD} 110 and output capacitor 108. Finally, if flyback converter 100 is operating in DCM or QRM, when the energy stored in the magnetizing inductor of transformer 104 is depleted, both primary transistor Q 104 and diode D 107 are turned off.

Flyback converter 100 also includes a flyback controller 116, which is attached to the gate of primary transistor Q 114 and turns primary transistor Q 114 on and off. Flyback controller 116 also controls the operation of switch SW1 126 that activates a discharge current path as is described in more detail below. (The connection between flyback controller 116 and switch SW1 126 is indicated by a dashed line in FIG. 1. Note that this connection may require some form of electrical isolation.) Flyback controller 116 can also receive inputs from current and voltage sensors within flyback converter 100, such as input 115 which can be used to monitor current in the primary current path.

To facilitate energy efficiency, flyback converter 100 also includes a discharge current path that can be selectively connected to and disconnected from the primary current path. More specifically, the discharge current path starts at the drain of primary transistor Q 114 and then feeds through a diode D 118, a resistor 120 and switch SW1 126 before feeding into a reservoir capacitor 128. This discharge current path is used to discharge the parasitic capacitance from primary transistor Q 114 into reservoir capacitor 128. Note that instead of including a resistor 120, discharge current path can alternatively include an inductor 124 to facilitate zero-voltage switching (ZVS) as is discussed in more detail below.

In some embodiments, reservoir capacitor 128 is used to power flyback controller 116, in which case the voltage on reservoir capacitor 128 is maintained close to V_{CC}. In these embodiments, reservoir capacitor 128 also receives power from a primary bias supply 132 through diode D 130. For example, primary bias supply 132 can be implemented as another winding in transformer 104 that provides power for flyback converter 116.

In other embodiments, reservoir capacitor 128 is alternatively used to power one or more other components within flyback converter 110, such as a monitoring circuit that monitors one of a current and a voltage in the flyback converter.

In yet other embodiments, charge contained in the reservoir capacitor 128 is returned to the primary current path, for example through circuitry that boosts the voltage provided by reservoir capacitor 128.

### Power Consumption in Flyback Converter Operating Modes

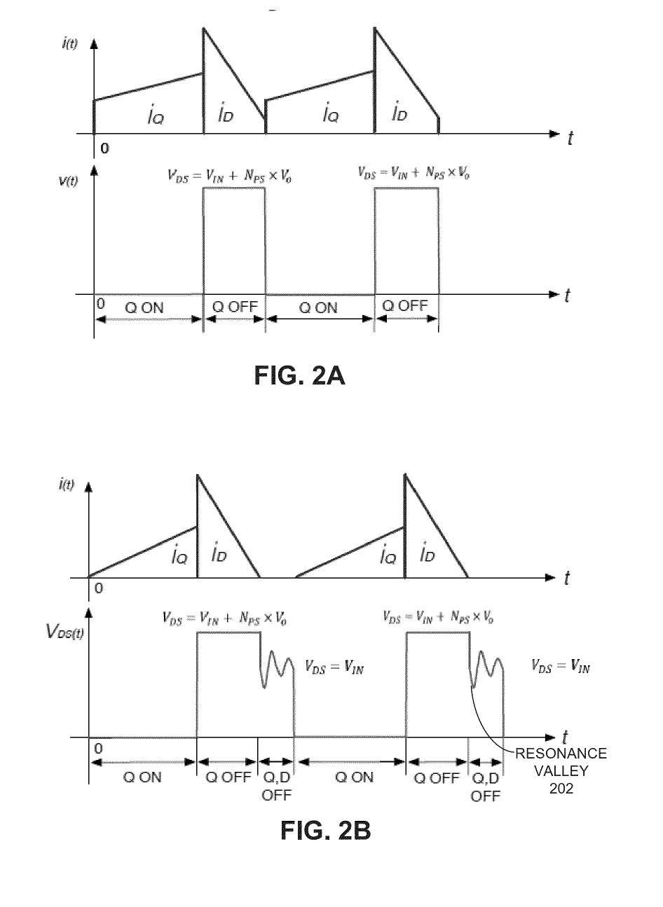

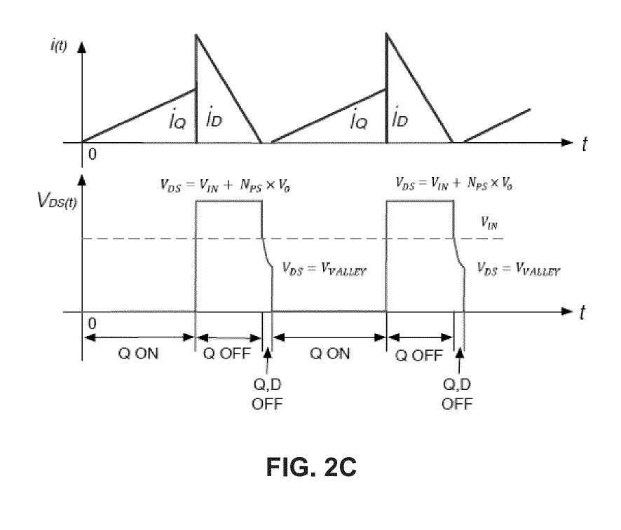

A conventional flyback converter has two switching modes: (1) a constant-frequency continuous-conduction mode (CCM), and (2) a constant-frequency discontinuous-conduction mode (DCM). In CCM, the primary transistor Q 114 (MOSFET) turns on before the output current decays to zero. Therefore, a CCM flyback converter operates using two states associated with primary transistor Q 114 and diode D 107: (1) Q on and D off; and (2) Q off and D on. The resulting voltage and current waveforms are depicted in FIG. 2A.

The power losses in a CCM flyback converter include a turn-on loss Pₒₙ having a first component Pₒₙ₁ associated with the non-zero current k through primary transistor Q 114, and a second component Pₒₙ₂ associated with the parasitic capacitance C_{OSS} in primary transistor Q 114. These components appear in the equations below, wherein N_{PS} is the turns ratio of the primary winding over the secondary winding, tₒₙ is the time that transistor Q114 is on during a switching cycle, t_{off} is the time that transistor Q 114 is off during a switching cycle, and F_{SW} is the switching frequency of transistor Q 114. (Note that the switching losses disclosed in this specification are intended to be illustrative of switching losses that may occur during different switching modes. Actual losses may vary depending on the overall converter design.)

Pₒₙ₁=1/2×(V_{IN}+N_{PS}×V_{O})×I_{Q}×tₒₙ×F_{SW}

Pₒₙ₂=1/2×C_{OSS}×(V_{IN}+N_{PS}×V_{O})²×F_{SW}

Pₒₙ=Pₒₙ₁+Pₒₙ₂

The power loss in CCM includes a turn-off loss P_{off}, which is associated with the non-zero current I_{Q} through primary transistor Q 114

P_{off}=1/2×(V_{IN}+N_{PS}×V_{O})×I_{Q}×t_{off}×F_{SW}.

In contrast to CCM, in DCM, primary transistor Q 114 turns on after the output current decays to zero. Hence, in DCM, the flyback converter operates using three states: (1) Q on and D off; (2) Q off and D on; and (3) both Q and D off. The resulting voltage and current waveforms are depicted in FIG. 2B.

The power losses in DCM include a turn-on loss Pₒₙ having a zero first component Pₒₙ₁ associated with the current I_{Q} through primary transistor Q 114, and a non-zero second component Pₒₙ₂ associated with the parasitic capacitance in primary transistor Q 114. These components appear in the equations below.

Pₒₙ₁=0

Pₒₙ₂=1/2×C_{OSS}×V_{IN}²×F_{SW}

Pₒₙ=Pₒₙ₁+Pₒₙ₂=Pₒₙ₂

The power loss in DCM similarly includes a turn-off loss P_{off}, which is associated with the non-zero current I_{Q} through primary transistor Q 114.

P_{off}=1/2×(V_{IN}+N_{PS}×V_{O})×I_{Q}×t_{off}×F_{SW}

In DCM, the current in primary transistor Q 114 starts from 0 A, so Pₒₙ₁=0. Hence, the turn-on loss in DCM is only related to the parasitic capacitance C_{OSS} discharging from the primary transistor Q 114. In contrast to DCM, in CCM the initial voltage for the parasitic capacitance C_{OSS} is V_{IN}+N_{PS}×V_{O}, while in DCM the initial voltage for the parasitic capacitance C_{OSS} is V_{IN}. Because the initial voltage for the parasitic capacitance C_{OSS} for DCM is lower than for CCM, the associated parasitic-capacitance-related switching loss for DCM is lower than CCM.

A flyback converter operating in QRM functions similarly to a flyback converter operating in DCM, except that primary transistor Q 114 is turned on at the instant when the drain-to-source voltage of primary transistor Q 114 rings down to a bottom of a resonance valley 202 illustrated in the lower portion of FIG. 2B.

The time delay for this resonance valley can be determined as follows. After primary transistor Q 114 is turned off and the current through the secondary path drops to 0 A, the drain-to-source voltage for primary transistor Q 114 begins to drop. When it drops below the input voltage level, a comparator flips which generates a time delay of ¼ resonant cycle:

$$\frac{π}{2} \times \sqrt{{L}_{p} \times {C}_{OSS}} ,$$

where Lₚ is the magnetizing inductance of the transformer, and C_{OSS} is the lump-sum parasitic capacitance of the primary transistor Q 114, the transformer winding, and the reflected capacitance from the secondary side. Hence, the flyback converter operates in three states: (1) Q on and D off; (2) Q off and D on; and (3) both Q and D off. The resulting voltage and current waveforms are depicted in FIG. 2C.

The power losses in QRM include a turn-on loss Pₒₙ having a zero first component Pₒₙ₁ associated with the current I_{Q} through primary transistor Q 114, and a non-zero second component Pₒₙ₂ associated with the parasitic capacitance in primary transistor Q 114.

Pₒₙ₁=0

Pₒₙ₂=1/2×C_{OSS}×(V_{IN}−N_{PS}×V_{O})²×F_{SW}

Pₒₙ=Pₒₙ₁+Pₒₙ₂=Pₒₙ₂

The power losses in QRM similarly include a turn-off loss P_{off}, which is associated with the non-zero current I_{Q} through primary transistor Q 114.

P_{off}=1/2×(V_{IN}+N_{PS}×V_{O})×I_{Q}×t_{off}×F_{SW}

Note that the turn-on loss in QRM, namely

Pₒₙ=1/2×C_{OSS}×(V_{IN}−N_{PS}×V_{O})²×F_{SW}

is lower than the corresponding turn-on loss in DCM

Pₒₙ=1/2×C_{OSS}×(V_{IN})²×F_{SW}.

Hence, operating a flyback converter in QRM can greatly reduce the turn-on switching when the input voltage is low, because the voltage of the parasitic capacitance C_{OSS} when the primary transistor is turned on is V_{IN}−N_{PS}×V_{O}, which is lower than V_{IN} for DCM. However, at high input voltages, the switching loss remains significant because V_{IN}−N_{PS}×V_{O} remains high. For example, for a 372V input voltage which is a rectified voltage of the AC utility power source of 264V_{AC}, V_{IN}−N_{PS}×V_{O} may be as high as 350V.

The voltage associated with the parasitic capacitance can be further reduced by using a new variation on a flyback converter operating in QRM that provides a discharging current path to facilitate discharging a parasitic capacitance from the primary transistor into a reservoir capacitor in accordance with the disclosed embodiments. The charge in this reservoir capacitor can subsequently be used to power other components in the flyback converter, or can be returned to the primary current path as is described in more detail below.

### New Variation on a Flyback Converter Operating in ORM

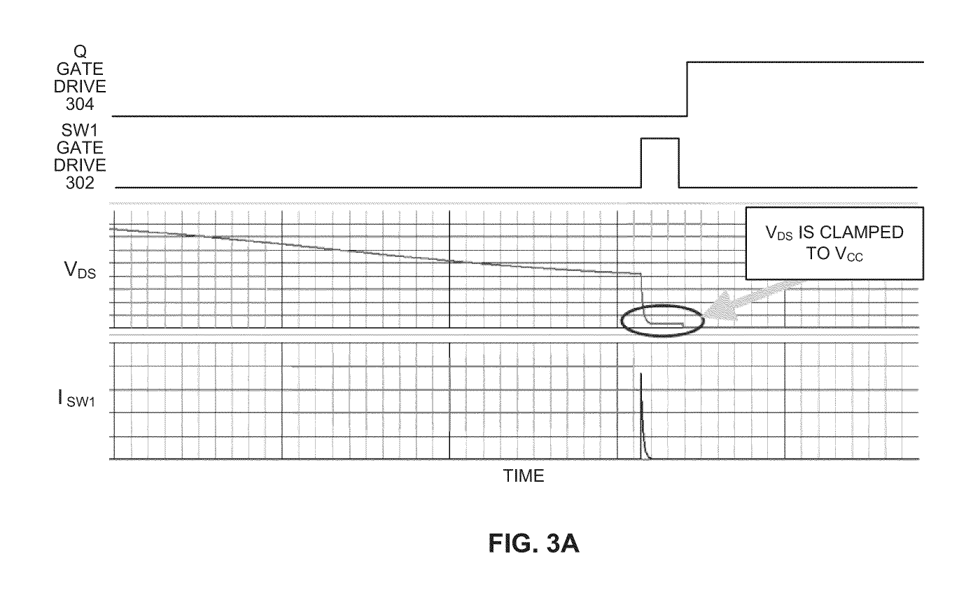

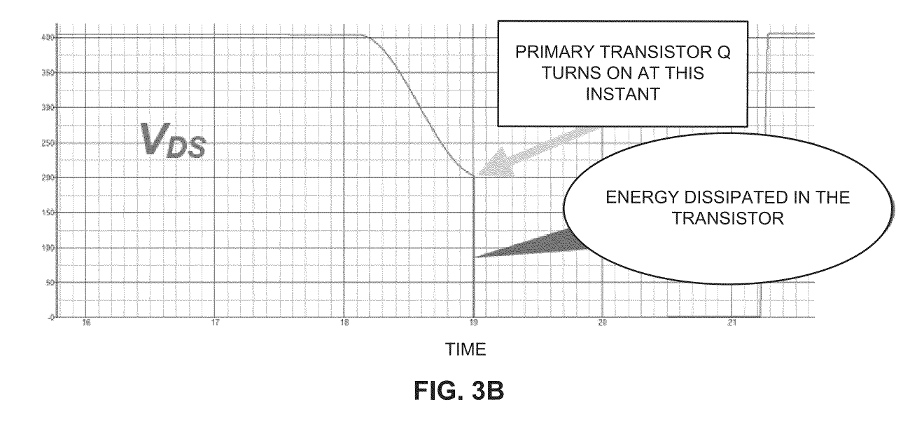

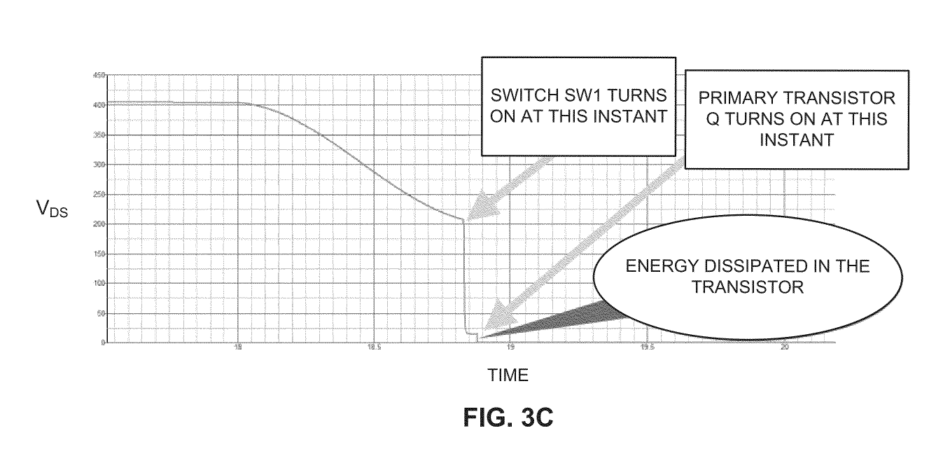

This new variation of a flyback converter operating in QRM functions similarly to conventional flyback converter operating in QRM, except that prior to the primary transistor Q 114 is turned on, switch SW1 126 (SW1 126 is a general switching device including MOSFET, BJT transistor, relay and etc.) is activated to complete a discharging current path from the drain of primary transistor Q 114, through diode D 118 and resistor 120 into reservoir capacitor 128, which is maintained at a voltage level of V_{CC} and is used to power other components in the flyback converter, such as flyback controller 116. (See FIG. 1). Note that SW1 126 is activated a sufficient amount of time before primary transistor Q 114 is turned on to allow V_{DS} to drop from V_{valley} to V_{CC}. When primary transistor Q 114 is finally turned on, the switching power dissipation is only caused by discharging the equivalent parasitic drain-to-source capacitance of primary transistor Q 114 from the V_{CC} level, which is much lower than the voltage discharged in conventional QRM. More specifically, in this new “V_{CC}-switching” variation of QRM, the energy dissipated in primary transistor Q 114 at turn on is ½×C_{OSS}×V_{CC}²×F_{SW}. (See FIG. 3C.) In contrast, the primary transistor turn-on power dissipation in a conventional QRM flyback converter is ½×C_{OSS}×V_{valley}²×F_{SW}. (See FIG. 3C.) The power consumption for this new V_{CC}-switching variation of QRM is much less because V_{CC} is usually 12V-15V, whereas V_{valley} is typically in the range from 100V to 300V. (Note that this new V_{CC}-switching variation of QRM effectively reduces switching losses by reusing energy that would otherwise be dissipated.)

A timing diagram illustrating the operation of the new V_{CC}-switching variation of QRM appears in FIG. 3A. The timing diagram starts after the primary transistor Q 114 is turned off, the current through the secondary path has dropped to 0 A, and the drain-to-source voltage V_{DS} for primary transistor Q 114 is dropping. Before V_{DS} reaches the bottom of the resonance valley, SW1 gate drive signal 302 is asserted to complete the discharging current path. (As mentioned above, SW1 126 is activated a sufficient amount of time before primary transistor Q 114 is turned on to allow V_{DS} to drop to V_{CC}.) This causes V_{DS} for primary transistor Q 114 to drop to V_{CC} and also causes the current through the discharging path I_{SW1} to spike, as is illustrated in the two graphs that appear in FIG. 3A. Finally, when V_{DS} reaches V_{CC}, SW1 gate drive signal 302 is reset to turn off SW1 126, and Q gate drive signal 304 is asserted to turn on primary transistor Q 114. Note that the same technique can also be applied to a flyback converter operating in DCM. In this case, the SW1 126 would similarly be turned on a sufficient amount of time before primary transistor Q 114 is turned on to allow V_{DS} to drop from V_{IN} to V_{CC} (instead of from V_{valley} to V_{CC}).

### Zero-Voltage-Switching (ZVS) Flyback Converter

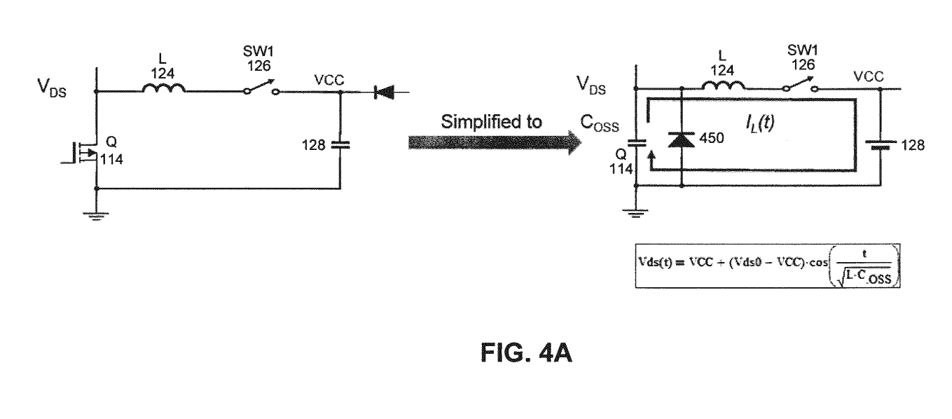

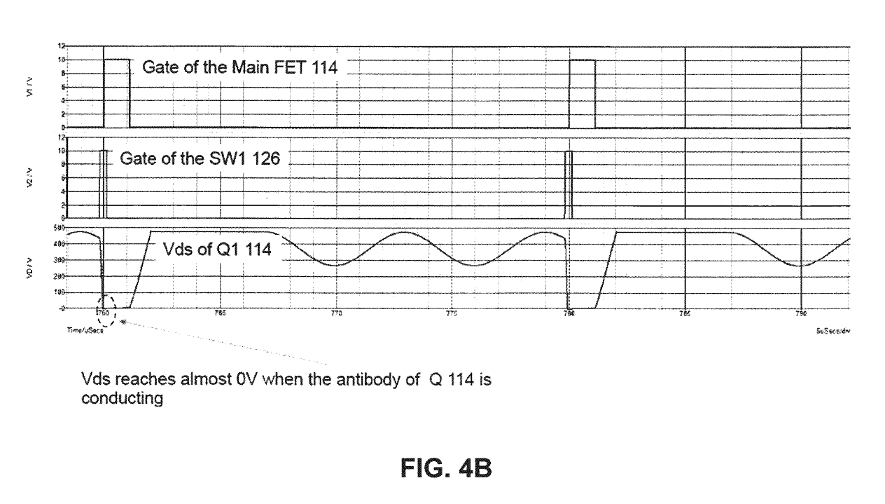

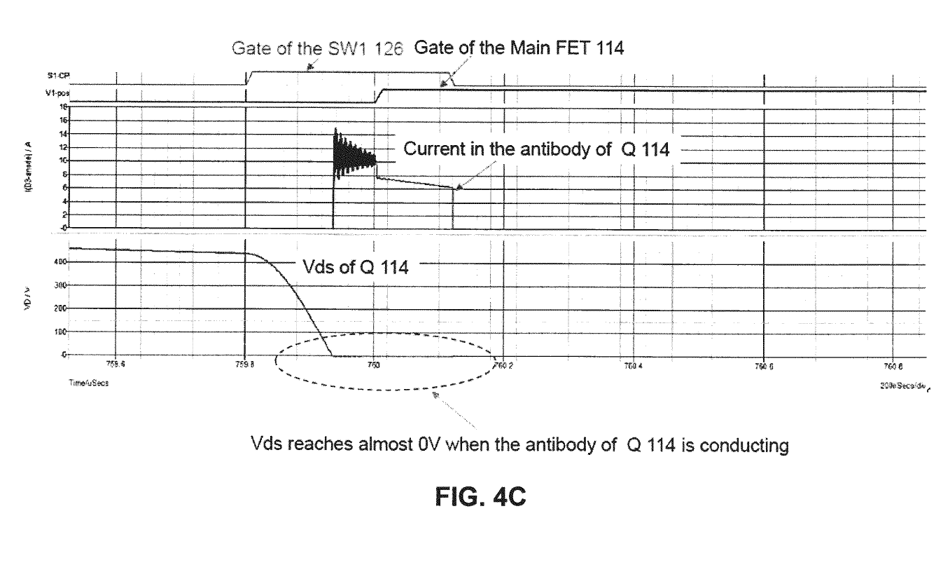

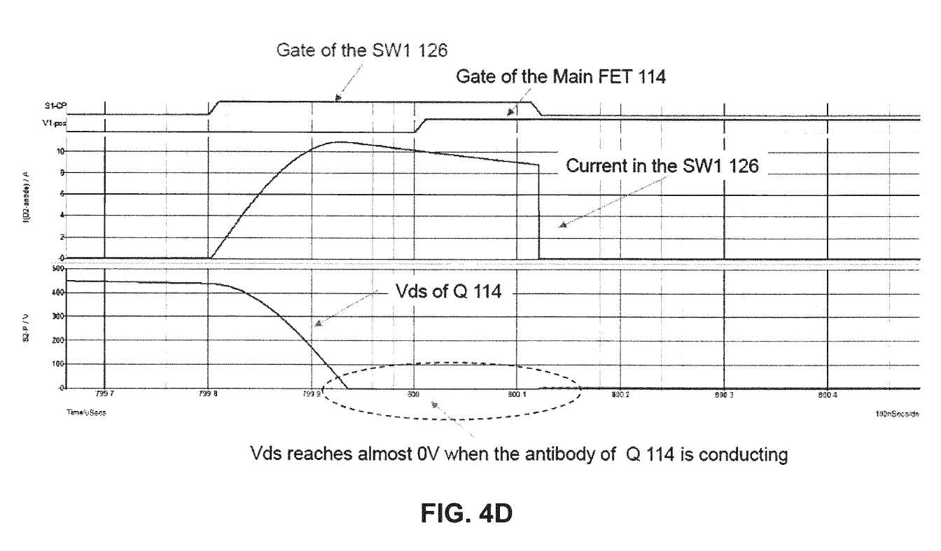

A zero-voltage-switching (ZVS) variation of a flyback converter operating in QRM achieves zero-voltage switching for primary transistor Q 114 by replacing resistor 120 with an inductor 124 in the discharging current path as is illustrated by the dashed lines in FIG. 1. This ZVS variation operates similarly to the above-described V_{CC}-switching variation of a flyback converter operating in QRM. When SW1 126 is turned on, the parasitic capacitance C_{OSS} of primary transistor Q114 and inductor 124 form an LC resonant circuit as is illustrated in FIG. 4A. The initial voltage across the parasitic capacitance C_{OSS} is V_{ds0}, which is the drain-to-source voltage V_{ds}(t) of Q 114 immediately before switch SW1 126 is turned on. When SW1 126 is turned on, the charge from parasitic capacitance C_{OSS} begins to discharge into reservoir capacitor 128 through inductor 124 and V_{ds}(t) begins to decrease as is illustrated in FIGS. 4B-4D. (Note that FIG. 4B illustrates V_{ds}(t) over an entire switching cycle, FIG. 4C illustrates the antibody diode current in primary transistor Q 114, and FIG. 4D illustrates the current through switch SW1 116.) When V_{ds}(t) reaches a level which is one diode drop (0.7V) below the ground return level, the antibody diode 450 (illustrated in FIG. 4A) begins to conduct as is illustrated by the graph of antibody diode current that appears in FIG. 4C. As the discharging current flows into the antibody diode 450 of Q 114, V_{ds}(t) is approximately one diode forward drop below the ground return level (−0.7V). Shortly after the antibody diode 250 of Q 114 becomes conducting, the gate of the Q 114 is turned on. At this instant, the voltage V_{ds}(t) across Q 114, is −0.7V and the current through Q 114 is the discharging current of reservoir capacitor 128, whose level is determined by the resonant circuit. Note that the turn-on loss of primary transistor Q 114 is the time integration of the product of V_{ds}(t) and the current I_{Q}(t) flowing through primary transistor Q 114. Because the single diode forward voltage is almost zero in comparison to the input voltage, the resulting turn-on loss is also almost zero. Hence, the above-described circuit essentially achieves zero voltage switching (ZVS).

Because the ZVS variation of the flyback converter turns on primary transistor Q 114 when V_{DS} is zero volts, the turn-on switching loss is 0 W. This is much lower than the ½×C_{OSS}×V_{valley}²×F_{SW} switching loss for a conventional flyback converter operating in QRM, or the ½×C_{OSS}×V_{CC}²×F_{SW} switching loss for the V_{CC}-switching variation of the flyback converter operating in QRM.

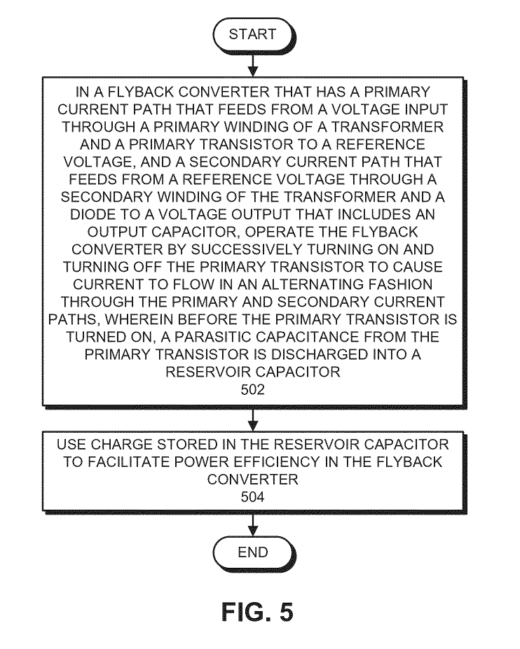

FIG. 5 presents a flow chart illustrating the process of operating a flyback converter in accordance with the disclosed embodiments. This flyback converter includes a primary current path that feeds from an input power source into a voltage input of the flyback converter, then through a primary winding of a transformer and a primary transistor to a primary ground, and a secondary current path that feeds from a secondary ground through a secondary winding of the transformer and a diode to a voltage output that includes an output capacitor. During operation of this flyback converter, the primary transistor is successively turned on and off to cause current to flow in an alternating fashion through the primary and secondary current paths to convert an input voltage received from the input power source at the voltage input into an output voltage provided to the voltage output and then to an output load, wherein before the primary transistor is turned on, a parasitic capacitance from the primary transistor is discharged into a reservoir capacitor (step 502). The system subsequently uses the charge stored in the reservoir capacitor to facilitate power efficiency in the flyback converter (step 504). As mentioned above, this can involve using the power in the reservoir capacitor to power other components in the flyback converter.

The detailed description that appears above is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a system reads and executes the code and/or data stored on the non-transitory computer-readable storage medium, the system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Moreover, the foregoing descriptions of disclosed embodiments have been presented only for purposes of illustration and description. They are not intended to be exhaustive or to limit the disclosed embodiments to the forms disclosed. Accordingly, many modifications and variations will be apparent to practitioners skilled in the art.

Additionally, the above disclosure is not intended to limit the disclosed embodiments. The scope of the disclosed embodiments is defined by the appended claims.

What is claimed is:

1. A flyback converter, comprising:
an input that receives an input voltage from an input power source;
an output that provides an output voltage;
a transformer with a primary winding and a secondary winding;
a primary current path that starts at the input and feeds through the primary winding of the transformer and a primary transistor to a primary ground;
a secondary current path that starts at a secondary ground and feeds through the secondary winding of the transformer to the output;
a discharge current path that selectively connects a drain of the primary transistor to a reservoir capacitor;
a controller configured to successively turn on and turn off the primary transistor to cause current to flow in an alternating fashion through the primary and secondary current paths to convert an input voltage received at the input to an output voltage provided to the output; and
circuitry that uses the reservoir capacitor as a power source.

2. The flyback converter of claim 1, wherein before the primary transistor is turned on, the controller is configured to activate a switch in the discharge current path to discharge a parasitic capacitance from the primary transistor into the reservoir capacitor.

3. The flyback converter of claim 1, wherein the impedance element in the discharge current path comprises a resistor.

4. The flyback converter of claim 1, wherein the impedance element in the discharge current path comprises an inductor.

5. The flyback converter of claim 4,
wherein the inductor and the parasitic capacitance of the primary transistor comprise a resonant circuit that causes the drain-to-source voltage of the primary transistor to ring down to zero volts during the discharging process; and
wherein the controller is configured to turn on the primary transistor when the drain-to-source voltage of the primary transistor reaches zero volts.

6. The flyback converter of claim 1, wherein the circuitry that uses the reservoir capacitor as a power source includes the controller.

7. The flyback converter of claim 1, wherein the circuitry that uses the reservoir capacitor as a power source includes a monitoring circuit that monitors one of a current and a voltage in the flyback converter.

8. The flyback converter of claim 1, wherein the circuitry that uses the reservoir capacitor as a power source includes circuitry that returns charge from the reservoir capacitor to the primary current path.

9. The flyback converter of claim 1,
wherein the flyback converter operates in a quasi-resonant mode;
wherein the controller is configured to start the discharging of the parasitic capacitance when the drain-to-source voltage V_{DS} of the primary transistor approaches a resonance valley, wherein the discharging of the parasitic capacitance causes V_{DS} to fall even further; and
wherein if the impedance element is a resistor, the controller is configured to turn on the primary transistor when V_{DS} falls to V_{CC}; and
wherein if the impedance element is an inductor, the controller is configured to turn on the primary transistor when V_{DS} falls to zero volts.

10. The flyback converter of claim 1, wherein the flyback converter operates in a discontinuous-conduction mode (DCM).

11. The flyback converter of claim 1, wherein the circuitry that uses the reservoir capacitor as a power source includes circuitry that is part of the flyback converter.

12. The flyback converter of claim 1, wherein the discharge current path starts at a drain of the primary transistor and feeds through a diode, an impedance element and a switch and into the reservoir capacitor.

13. A method for operating a flyback converter, comprising:
operating the flyback converter having a primary current path that feeds from an input power source into a voltage input of the flyback converter, then through a primary winding of a transformer and a primary transistor to a primary ground, and a secondary current path that feeds from a secondary ground through a secondary winding of the transformer to a voltage output;
wherein operating the flyback converter includes successively turning on and turning off the primary transistor to cause current to flow in an alternating fashion through the primary and secondary current paths to convert an input voltage received at the voltage input to an output voltage provided to the voltage output;
wherein before the primary transistor is turned on, the method further comprises discharging a parasitic capacitance from the primary transistor into a reservoir capacitor; and
using charge stored in the reservoir capacitor as a power source.

14. The method of claim 13, wherein discharging the parasitic capacitance from the primary transistor into the reservoir capacitor includes discharging the primary transistor through a discharge current path that starts at a drain of the primary transistor and feeds through a diode, a resistor and a switch and then into the reservoir capacitor.

15. The method of claim 13, wherein discharging the parasitic capacitance from the primary transistor into the reservoir capacitor includes discharging the primary transistor through a discharge current path that starts at a drain of the primary transistor and feeds through a diode, an inductor, and a switch and then into the reservoir capacitor.

16. The method of claim 15,
wherein the inductor and the parasitic capacitance of the primary transistor comprise a resonant circuit that causes the drain-to-source voltage of the primary transistor to reach zero volts during the discharging process; and
wherein the primary transistor is turned on when the drain-to-source voltage of the primary transistor reaches zero volts.

17. The method of claim 13, wherein using the charge stored in the reservoir capacitor to facilitate power efficiency includes using the charge to power a controller for the flyback converter.

18. The method of claim 13, wherein using the charge stored in the reservoir capacitor to facilitate power efficiency includes using the charge to power a monitoring circuit that monitors one of a current and a voltage in the flyback converter.

19. The method of claim 13, wherein using the charge stored in the reservoir capacitor to facilitate power efficiency includes returning the charge to the primary current path in the flyback converter.

20. The method of claim 13,
wherein the flyback converter operates in a quasi-resonant mode;
wherein the discharging of the parasitic capacitance starts when the drain-to-source voltage V_{DS} of the primary transistor approaches a resonance valley, wherein the discharging of the parasitic capacitance causes V_{DS} to fall even further; and
wherein if the impedance element is a resistor, the primary transistor turns on when V_{DS} falls to V_{CC}; and
wherein if the impedance element is an inductor, the primary transistor turns on when V_{DS} falls to zero volts.

21. The method of claim 13, wherein the flyback converter operates in a discontinuous-conduction mode (DCM).

23. The method of claim 13, wherein using the charge stored in the reservoir capacitor as a power source includes using the charge to power circuits in the flyback converter.

24. A non-transitory computer-readable storage medium containing instructions that, when executed by a controller, cause the controller to perform a method for controlling a flyback converter, the method comprising:
operating the flyback converter having a primary current path that feeds from an input power source into voltage input of the flyback converter, then through a primary winding of a transformer and a primary transistor to a primary ground, and a secondary current path that feeds from a secondary ground through a secondary winding of the transformer to a voltage output;
wherein operating the flyback converter includes successively turning on and turning off the primary transistor to cause current to flow in an alternating fashion through the primary and secondary current paths to convert an input voltage received at the voltage input to an output voltage provided to the voltage output; and
wherein before the primary transistor is turned on, the method further comprises discharging a parasitic capacitance from the primary transistor into a reservoir capacitor, wherein charge stored in the reservoir capacitor is used to facilitate power efficiency in the flyback converter.

25. The non-transitory computer-readable storage medium of claim 24, wherein the charge stored in the reservoir capacitor is used to power the controller for the flyback converter.
